(19) United States
(12) Patent Application Publication
(10) Pub. No.: US 2023/0138936 A1
(43) Pub. Date: May 4, 2023

(54) FLYWHEEL ASSEMBLY FOR POWERING AN ELECTRICAL GENERATOR

(71) Applicants: Clinton William Walker, III, Greenville, MS (US); Tyler Barrett Williams, Red Wing, MN (US)

(72) Inventors: Clinton William Walker, III, Greenville, MS (US); Tyler Barrett Williams, Red Wing, MN (US)

(21) Appl. No.: 17/962,999

(22) Filed: Oct. 10, 2022

Related U.S. Application Data
(60) Provisional application No. 63/273,839, filed on Oct. 29, 2021.

(51) Int. Cl. H02K 7/02

(52) U.S. Cl. CPC H02K 7/02

(57) ABSTRACT

Flywheel assembly for powering an electrical generator including a flywheel connecting a small gear and larger second gear. The flywheel, small first gear, larger second gear, all bearings, rotor and stator are connected via an axle. The path of the flywheel is restricted to a circular or other geometrically confined area through the use of bearings, bearing races and other support structures. The fixed ring gears create and maintain the rotational motion of the flywheel so that it always spins in the same direction, and are positioned on either the outside or inside of the confined flywheel assembly path or area. The positioning of the ring gears is consistent with each other so as to maintain continuous rotation of the flywheel in the same direction at all times. In either event, the flywheel always returns to the original point of origin. On the downward path, utilizing the smaller gear, the flywheel travels down the path and picks up speed with each rotation, storing energy in the flywheel as it goes. The accumulated energy in the flywheel during the multiple rotations on the path down is more than sufficient to complete the rotation(s) required to return the flywheel to the top of the flywheel assembly path using the larger second gear.

### RELATED APPLICATIONS AND CLAIM FOR PRIORITY

The present application claims priority from U.S. Provisional Patent Application Ser. No. 63/273,839 filed Oct. 29, 2021, and titled “A FLYWHEEL ASSEMBLY FOR POWERING AN ELECTRICAL GENERATOR,” with Attorney Docket No. WALK001USP, which is incorporated herein by its entirety and referenced thereto.

### FIELD OF INVENTION

The present invention generally relates to flywheel mechanisms and their uses. More specifically, the present invention relates to a flywheel assembly utilizing gravitational force for powering an electrical generator/alternator.

### BACKGROUND OF INVENTION

Different techniques or methodologies are utilized to generate electricity. Some of the techniques include use of hydro-electric dams, burning of fossil fuels such as coal, oil and natural gas, wind, solar, nuclear, geothermal, tidal forces and the like. Each of the techniques of electricity generation possesses its own unique set of serious flaws and disadvantages. For example, hydro-electric dams are only available where large rivers have been dammed up and are extremely expensive to construct and maintain. The burning of fossil fuels causes pollution and climate change. Wind generation requires very large areas of open land or water and can only operate when the wind is favourable (not too high or too light). Wind energy is not available in most metropolitan locations. Solar can only be utilized during daylight hours and is not effective on cloudy days. Thus, solar is available, at best, only 10 hours a day. Like wind, solar energy requires large land or sea areas. Nuclear energy is expensive to construct, extremely hazardous to operate and maintain, and present problems with waste and decommissioning. Geothermal is available only in limited locations. Tidal energy is extremely limited geographically, hazardous as obstructions to navigation, extremely expensive, and unproven economically.

For more than 100 years now, man has been using gravity to generate electricity. Generating electricity through the use of gravity is accomplished by damming up rivers and permitting gravitational forces to accumulate in the form of the headwaters above a dam. The accumulated gravitational forces are then utilized in the form of water under high pressure due to the force of gravity stored in the weight of the water piled up behind the dam. In this scenario, the dam acts as an “accumulator” of the gravitational forces.

With recent improvements in technology, flywheels have now also been used as “accumulators” of kinetic energy to store and release electrical energy. These are known as flywheel energy storage systems (FESS). However, the flywheels have not been used as the initial “accumulators” of kinetic energy to produce the electricity.

It is desirable to utilize flywheels to act as the initial accumulators of kinetic energy produced by gravitational forces, including the quadratic characteristics of gravitational acceleration, to power these flywheels; which in turn, power electrical generators and/or alternators.

Therefore, there is a need for a flywheel assembly to act as the initial accumulator of kinetic energy utilizing gravity as the driving force for powering an electrical generator.

### SUMMARY

It is an object of the present invention to provide a flywheel for powering an electrical generator and that avoids the drawbacks of known techniques.

It is another object of the present invention to provide a flywheel that acts as an accumulator of kinetic energy produced by gravitational forces, and to harvest the quadratic acceleration forces of gravity to power electrical generators and/or alternators.

It is another object of the present invention to provide a unique way of providing power generation at all times in any geographical location and to avoid or reduce the use of fossil fuels.

In order to achieve one or more objects here stated, the present invention provides a flywheel assembly for powering an electrical generator/alternator. The flywheel assembly includes a flywheel connecting a first gear and a second gear. The first gear is much smaller than the second gear. The flywheel, the first gear, the second gear, the bearings, the rotor, and the housing for the stator are all connected via an axle. The combination of the flywheel/rotor, the first gear, the second gear, the bearings, the housing for the stator and the axle are referred to as “flywheel assembly”. The path of the flywheel assembly (or “flywheel assembly path”) is restricted to a circular or other geometrically confined area by bearings, bearing races and other support structures. The diameter or circumference of the flywheel is larger than the diameter or circumference of the flywheel assembly path. The fixed semi-circular ring gears are mounted parallel to each other, yet in different planes so as to coincide with the respective large and small gears on the flywheel assembly. The gear teeth on both the small gear and the large gear on the flywheel assembly must be synchronized with both the small and large semi-circular ring gears so as to insure smooth and continuous rotation of the flywheel assembly. The fixed semi-circular ring gears are permanently mounted so as to create and maintain rotational motion of the flywheel so that it always spins in the same direction. The fixed semi-circular ring gears could be positioned on either the inside or the outside of the confined flywheel assembly path. However, they must be consistent with each other to maintain continuous rotation of the flywheel assembly in the same direction at all times. In either event, the flywheel assembly path always returns the flywheel to its original point of origin. The invention is started by positioning the flywheel assembly near the top of the flywheel assembly path with the small gear in engagement with the small semi-circular ring gear. The force of gravity causes the entire flywheel assembly to travel in a downward direction down the small semi-circular ring gear. On the downward path of the flywheel assembly, the small gear, on the flywheel assembly contacts a small, fixed semi-circular ring gear that is firmly and permanently affixed to the structure housing on the downward flywheel assembly path. Since the semi-circular ring gear is fixed in place and cannot move, and small gear, firmly affixed to the flywheel assembly is free to move within the bearings supporting the flywheel assembly. As the flywheel assembly begins its descent down the small semi-circular ring gear, the flywheel assembly begins to rotate or spin as it travels down the flywheel assembly path. As a result of the small diameter of the gear on the flywheel assembly, the flywheel assembly requires multiple rotations and additional time to reach the bottom of the flywheel assembly path. As the flywheel travels down the flywheel assembly path, due to the quadratic nature of gravity, it continues to pick up speed with each rotation, storing and accumulating kinetic energy in the flywheel as it goes.

At the bottom of the flywheel assembly path, the small semi-circular ring gear ends, and a much larger fixed semi-circular ring gear begins. The large semi-circular ring gear, like the small semi-circular ring gear, is firmly and permanently affixed to the structure housing. The large semi-circular ring gear corresponds with a much larger gear on the flywheel assembly. Due to the large difference in the size of the gears, the rotations and time required to return the flywheel assembly to the top of the path are greatly reduced. At this point, the large gear on the flywheel assembly is being powered by the kinetic energy that has been stored or accumulated in the flywheel during its downward path. The accumulated kinetic energy stored in the flywheel during the multiple rotations and extended time on the path down is more than sufficient to complete the much fewer rotation(s) and less time required to return the flywheel assembly to the top of the flywheel assembly path.

In order to use the flywheel assembly to generate electricity, the outside of the flywheel serves as a rotor, with a stabilized stator in the stator housing encircling it. Alternatively, the two ends of the axle on the flywheel assembly house both rotors and stators. Alternatively, several other combinations of rotors and stators can be applicable to generate electricity.

In one advantageous feature of the present invention, the flywheel is used as the initial accumulator to produce and store kinetic energy, which in turn, is used to produce electricity. Further, the flywheel is utilized as an accumulator of gravitational forces, and the quadratic acceleration forces of gravity to power electrical generators and/or alternators. Since gravity is used as the driving force for the flywheel, the flywheel assembly can be used at all times (24 hours a day, 365 days a year) and in any geographical location. In addition, it is not hazardous to the environment, and does not require the purchase of any fuel to run. Further, since it requires the purchase of no fuel, it is cheaper than fossil fuel and nuclear driven generators and available for use even in the most impoverished parts of the world.

In the disclosed invention, the kinetic energy stored within the flywheel increases, quadratically, with each additional second the flywheel assembly spends traveling down the flywheel assembly path as opposed to the much faster trip it takes to go up the flywheel assembly path. Additionally, due to the dramatic difference between the size of the small gear and number of teeth on the small gear as opposed to the size of the large gear and number of teeth on the large gear, the number of rotations and time needed to reach the bottom of the flywheel assembly path is much greater than the rotation(s) and time needed to return the flywheel assembly to the top of the flywheel assembly path.

In another advantageous feature of the present invention, the flywheel assembly can then be used to generate electricity at all times (24 hours a day, 365 days a year) in any geographical location, worldwide.

In one implementation, the flywheel has a diameter or circumference greater than the diameter or circumference of the flywheel path. Further, the flywheel has a moment of inertia greater than the combined moments of inertia of both the first gear and the second gear. In the present invention, the flywheel is utilized as the initial accumulator of kinetic energy created through gravitational forces to generate electricity.

Features and advantages of the invention hereof will become more apparent in light of the following detailed description of selected embodiments, as illustrated in the accompanying FIGURES. As will be realised, the invention disclosed is capable of modifications in various respects, all without departing from the scope of the invention. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates a schematic diagram of a flywheel assembly, supporting structure, and housing for the device, in accordance with one exemplary embodiment of the present invention;

FIGS. 2, 3 and 5 illustrate a schematic diagram a cross-sectional view, and a prospective view respectively of the flywheel assembly and supporting structure in a downward path or descent, in accordance with one embodiment of the present invention;

FIGS. 4 and 6 illustrate a schematic diagram, and a cross-sectional view, respectively of the flywheel assembly and supporting structure in an upward path or ascent, in accordance with one embodiment of the present invention;

FIG. 7 illustrates a side profile of the flywheel assembly, in accordance with one embodiment of the invention;

FIG. 8 illustrates a cross-sectional view of the flywheel assembly and supporting structures including monorail, magnetic bearings and magnetic gears, in accordance with another embodiment of the present invention;

FIGS. 9 and 10 illustrate schematic diagrams of the flywheel assembly and supporting structures utilizing a monorail and magnetic gears and magnetic bearings in downward path and upward path, respectively, in accordance with one embodiment of the present invention;

FIG. 11 illustrates a top perspective view of a flywheel assembly and supporting structures, in accordance with one exemplary embodiment of the present invention;

FIGS. 12 and 13 illustrate a perspective view of a first housing and a second housing, respectively of the flywheel assembly, in accordance with one exemplary embodiment of the present invention;

FIG. 14 illustrates an operational view of the small gear at the top of the small ring gear, during downward path, in accordance with one exemplary embodiment of the present invention; and

FIG. 15 illustrates an operational view of the large gear at the bottom of the large ring gear, during upward path, in accordance with one exemplary embodiment of the present invention.

It will be noted that throughout the appended drawings, like features are identified by like reference numerals.

### DETAILED DESCRIPTION OF THE EMBODIMENTS

Before the present features and working principle of a flywheel assembly is described, it is to be understood that this invention is not limited to the particular device as described, since it may vary within the specification indicated. Various features of the flywheel assembly might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present invention describes a flywheel assembly to act as an initial kinetic energy accumulator to be used in powering an electrical generator. The flywheel assembly includes a flywheel connecting a small first gear and a much larger second gear having a substantial size and gear tooth difference in the embodiment depicted. In addition, the diameter or circumference of the flywheel is larger than the flywheel assembly path. Here, the flywheel/rotor, the first gear and the second gear, bearings and housing for the stator are connected via an axle. The combination of the flywheel/rotor, the first gear, the second gear, the bearings, the housing for the stator and the axle are referred to as the “flywheel assembly”. The path of the flywheel assembly is restricted to a circular or other geometrically confined area by bearings, bearing races flywheel support arms and other support structures. The fixed semi-circular ring gears are mounted parallel to each other, yet in different planes so as to coincide with the respective large and small gears on the flywheel assembly. The gear teeth on both the small gear and the large gear on the flywheel assembly must be synchronized with both the small and large semi-circular ring gears so as to insure smooth and continuous rotation of the flywheel assembly. The fixed semi-circular ring gears are permanently mounted so as to create and maintain rotational motion of the flywheel assembly so that it always spins in the same direction. In order to function properly, the flywheel assembly must always descend the small fixed semi-circular ring gear and ascend the large fixed semi-circular ring gear. In the diagrams depicted, the semi-circular ring gears (be they mechanical or magnetic) run on the outside of the confined circular area, and always return to its point of origin. On the downward path of the flywheel assembly, gravity causes the entire flywheel assembly to begin its downward path. As it descends, the small gear comes into contact with the small, fixed semi-circular ring gear. Since the small semi-circular ring gear is fixed and cannot move, the small gear, which is permitted to rotate due to the fact that as part of the flywheel assembly, floating within its bearings, begins to rotate. Since the small gear is firmly affixed to the flywheel assembly axle, this causes the entire flywheel assembly, including the flywheel and large gear, to also rotate. At this point in time, the quadratic force of gravity, coupled with rotation of the flywheel as it travels the downward path, causes the flywheel to spin, storing kinetic energy in the flywheel as it descends. It is important to note that the diameter or circumference of the flywheel is always larger than the diameter or circumference of the flywheel assembly path. It is also important to note that on the downward path, neither the large gear on the flywheel assembly nor the large fixed semi-circular ring gear on the supportive structure come into play since they do not contact anything on the downward path. At the bottom of the flywheel assembly path, the small semi-circular ring gear comes to an end, and the large semi-circular ring gear, itself also firmly and permanently affixed to the structure housing, begins. At the bottom of the flywheel assembly path, the large gear, which is firmly affixed to the flywheel assembly, is spinning at the same rate as the entire flywheel assembly. At this point, the large gear on the flywheel assembly engages with the large fixed semi-circular ring gear, and the kinetic energy accumulated in the flywheel during the multiple rotations and extended time on the path down is more than sufficient to complete the rotation(s) and lesser time required to return the flywheel assembly to the top of the flywheel assembly path. On the path upward, the large gear on the flywheel assembly is being powered by the kinetic energy that has been accumulated in the flywheel during the extended time and multiple rotations required on the path down. Accordingly, on the trip back up the flywheel assembly path, the large gear on the flywheel assembly is powered by the kinetic energy that is stored in the flywheel. Since the large ring gear is stationary, the flywheel assembly climbs back up the flywheel assembly path. However, since the gear ratio is so much larger on the way up as opposed to the way down, the trip up takes far fewer rotations, and requires much less time. To use the flywheel assembly in generating electricity, the outside of the flywheel serves as a rotor, with a stabilized stator in the housing encircling it. Alternatively, the two ends of the axle house both rotors and stabilized stators. Alternatively, several other combinations of rotors and stators can be applicable to generate electricity.

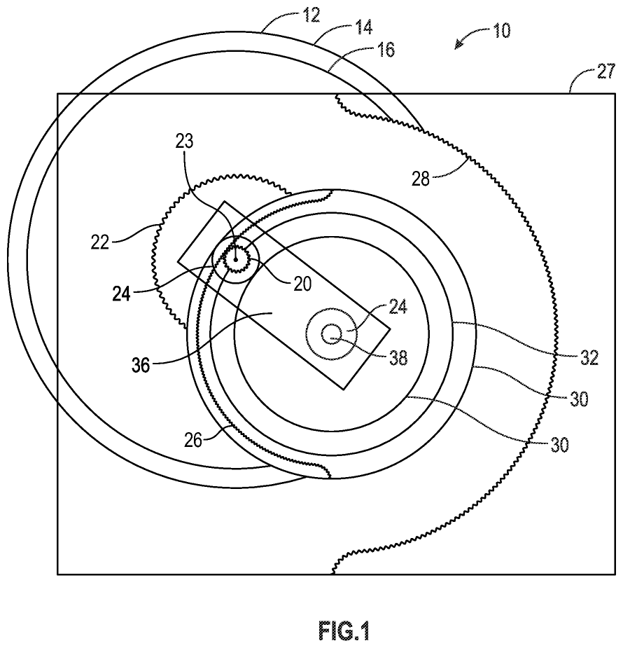

Various features and embodiments of the flywheel assembly for powering an electrical generator are explained in conjunction with the description of FIGS. 1-15.

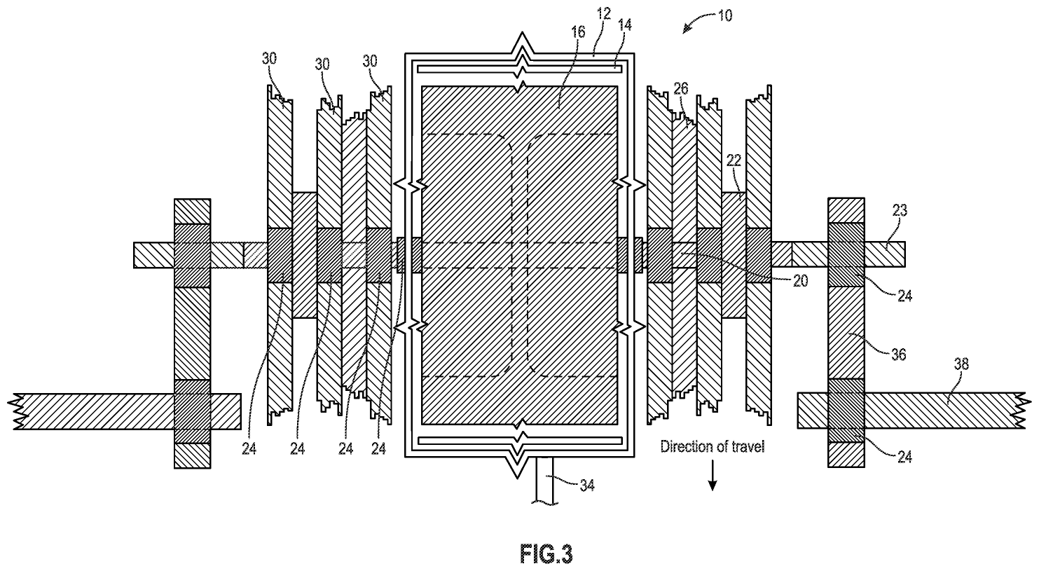

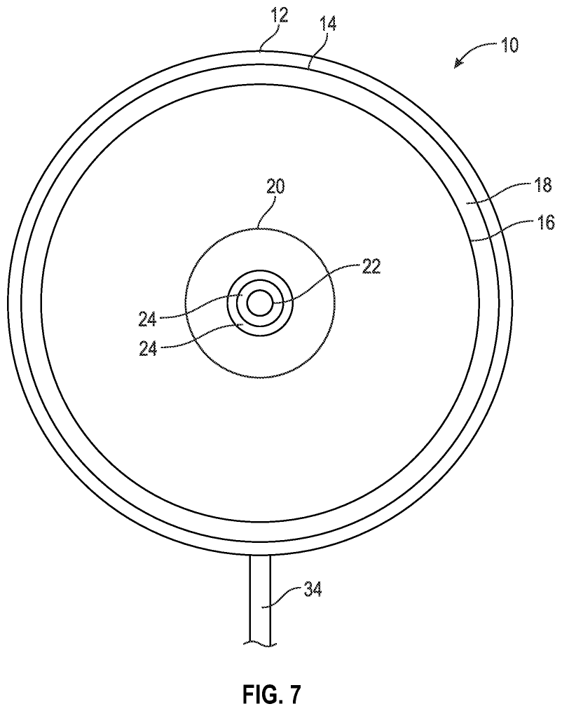

FIG. 1 shows a schematic diagram of one embodiment of the invention utilizing gravity for powering an electrical generator, in accordance with one embodiment of the present invention. Flywheel assembly 10 (also shown in FIGS. 3, 6 and 7) and includes generator 12. Generator 12 encompasses stator 14. Further, generator 12 encompasses flywheel/rotor 16. Stator 14 and flywheel/rotor 16 present an empty space 18, as shown in FIG. 7.

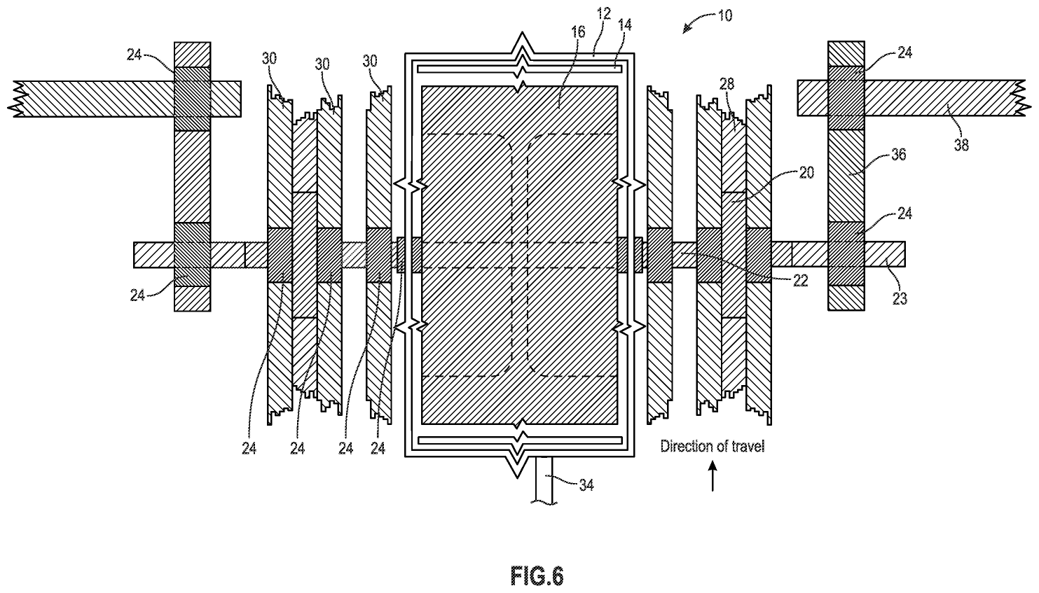

Flywheel assembly 10 includes first small gears 20 and second larger gears 22. Here, first gears 20 are smaller than second gears 22. In the present embodiment, the ratio, as depicted, between first gears 20 and second gears 22 is 1:7. However, the ratio between first gears 20 and second gears 22 can be even more or less depending on the need. Flywheel assembly 10 includes flywheel assembly axle 23 connecting flywheel/rotor 16, first gears 20 and second gears 22 as shown in at least FIGS. 3 and 6. The small gears 20 engage small fixed semi-circular ring gears 26 to rotate the flywheel assembly 10, and the large gears 22 engage large fixed semi-circular ring gears 28 to traverse the flywheel assembly path 32 back to the top.

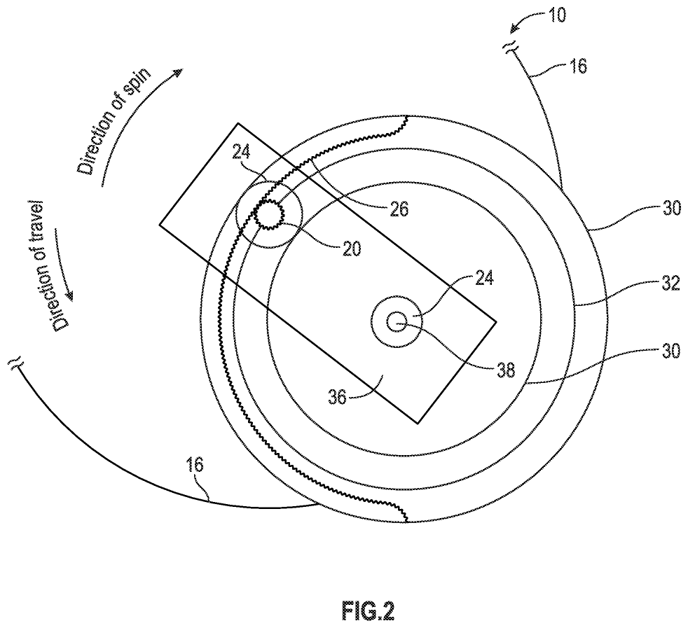

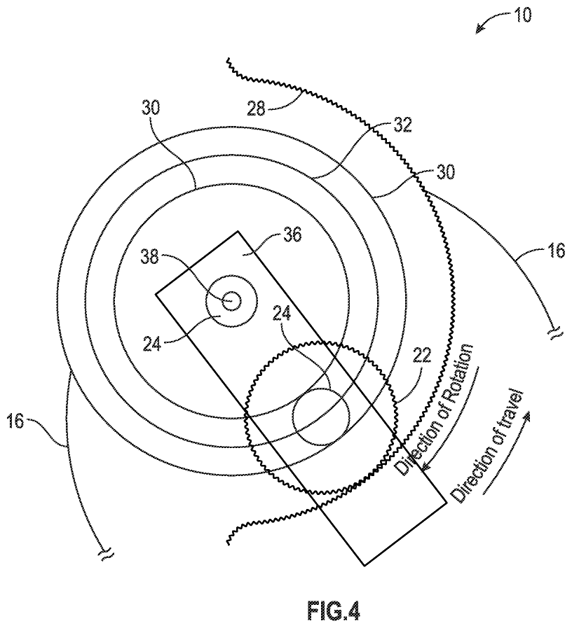

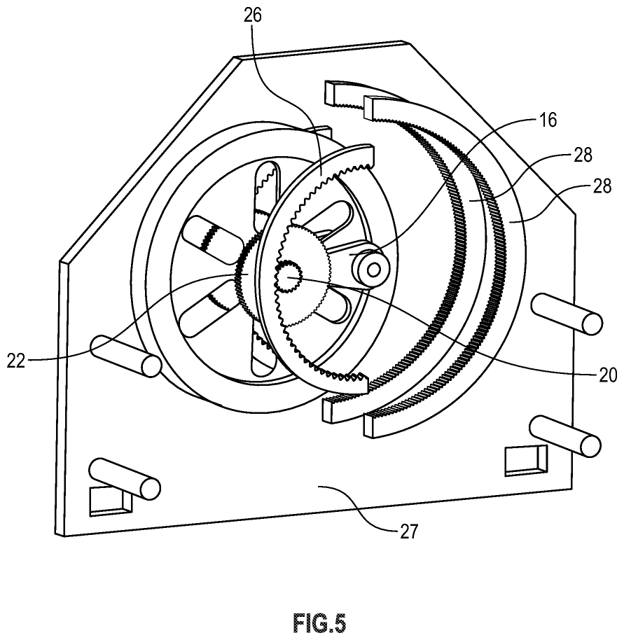

Flywheel assembly axle 23 presents bearings 24 for connecting first gears 20 and second gears 22. In one example, a total of eight bearings 24 are used. However, a person skilled in the art understands that any number of bearings 24 can be used depending on the need without departing from the scope of the present invention. In the present embodiment, first small gears 20 (small gears) operate with the help of first small fixed semi-circular ring gears 26 (small ring gears) and second larger gears 22 (large gears) operate with the help of second larger fixed semi-circular ring gears 28 (large ring gears). The small fixed semi-circular ring gears 26 and the large fixed semi-circular ring gears 28 are mounted parallel to each other, yet in different planes so as to coincide with the respective small gears 20 and large gears 22 on the flywheel assembly. The fixed semi-circular small ring gears 26 and fixed semi-circular large ring gears 28 are permanently mounted so as to create and maintain rotational motion of the flywheel assembly 10 so that it always spins in the same direction. Each of small ring gears 26 and large ring gears 28 include gear teeth (shown in FIGS. 2 and 4) at their inner side and engage gear teeth on the outside of the small gears 20 and the large gears 22, respectively. The gear teeth on both the small gears 20 and the large gears 22 on the flywheel assembly must be synchronized with both the small semi-circular ring gears 26 and the large semi-circular ring gears 28 so as to insure smooth and continuous rotation of the flywheel assembly. Moreover, wherever doing so may be considered beneficial, gear teeth may be modified to gear interfaces to advance smooth and precise relationships amongst the different moving and contacting surfaces. Further, bearing races 30 are positioned on both sides of the small ring gears 26 and the large ring gears 28. Flywheel assembly 10 (as shown in FIGS. 3 and 6) positions in container or box 27 (as shown in FIGS. 1 and 5) which hold stationary the bearing races 30, the small ring gears 26 and the large ring gears 28.

In order to support, maintain and stabilize the flywheel assembly within flywheel assembly path 32, at least one flywheel assembly support arm 36 is affixed via bearings 24 to axle 23 (or flywheel assembly axle 23) and also to one or more centreline axle(s) 38. Alternatively, one or more support arms 36 suspend from opposite facing bearing races 30 to support, maintain and stabilize the flywheel assembly.

Flywheel 16 rotates around flywheel assembly path 32 between bearing races 30 during the descent (downward path) and ascent (upward path). Flywheel assembly path 32 is restricted to a circular or any other geometrically confined area so that the rotational motion of flywheel 16 always spins in the same direction, running always within the confined area, and always returning to its point of origin. Flywheel 16 is held in place by bearings 24 and bearing races 30 and flywheel assembly support arms 36 affixed to one or more centreline axles 38. It is important that the diameter of flywheel 16 is always larger than flywheel assembly path 32. Flywheel assembly 10 connects to brushes or cable assembly 34 for transmitting the energy generated by the electrical generator/alternator created by the flywheel/rotor 16 and the stator 14. The flywheel assembly path 32 can be reduced or enlarged so as to maximize the speed and efficiency of flywheel 16.

Now referring to FIGS. 2, 3, and 5, operation of flywheel 16 in a downward path or descent is explained. The flywheel assembly is supported, maintained and stabilized within flywheel assembly path 32 by bearings 24, bearing races 30, flywheel assembly axle 23, flywheel assembly support arms 36 and one or more centreline axle(s) 38. On the descent, or downward path of flywheel 16, the small gears 20 and the small ring gears 26 are active. On the downward path, the small gears 20 come into contact with small ring gears 26 on the downward flywheel assembly path 32. As a result of the smaller diameter of the small gears 20, and fewer teeth, the flywheel 16 requires multiple rotations and time to reach the bottom of flywheel assembly path 32. As flywheel 16 travels down the flywheel assembly path 32, flywheel assembly 10 continues to pick up speed with each rotation, storing kinetic energy in flywheel 16. During the downward movement of flywheel assembly 10, small ring gears 26 which are stationary force the rotation of the flywheel assembly 10. Further, on the decent, the large gears 22 do not come in contact with any other part. As such, large gears 22 are not shown in FIG. 2. Further, small ring gears 26 and large ring gears 28 and one or more centreline axles 38 (shown on FIG. 1, not shown on FIG. 2) are fixed and always remain stationary. During descent, flywheel assembly 10 (including flywheel/rotor 16, small gears 20, large gears 22, flywheel assembly axle 23, bearings 24 and stator 14, stator housing 12 and flywheel assembly support arms 36) move and remaining parts stay stationary.

At the bottom of flywheel assembly path 32, small ring gears 26 end, and the much larger ring gears 28 begin. Here, the large ring gears 28 correspond with the much larger gears 22 on flywheel assembly 10. Due to the large difference in the size of the gears and number of teeth, the rotations (and time) required to return the flywheel 16 to the top of flywheel assembly path 32 are greatly reduced. At this point in time, the large gears 22 on flywheel assembly 10 (i.e., on the entire flywheel/gear assembly) are propelled upwards by the kinetic energy stored in the flywheel 16. The accumulated kinetic energy in flywheel 16 during the multiple rotations on flywheel assembly path 32 down (downward path) is more than sufficient to complete the rotation(s) required to return the flywheel assembly 10 to the top of flywheel assembly path 32. The above repeats leading to continuous rotation of flywheel assembly 10.

As specified above, the ratio, in this depiction, between small gears 20 and large gears 22 is 1:7. The flywheel assembly path 32 is designed to optimize the number of rotations down versus the number of rotations needed to return the flywheel assembly 10 to the point of origin. On the descent, flywheel assembly 10 requires seven (7) rotations before it reaches the bottom. Each rotation down is going to be faster, quadratically, than the rotation immediately preceding it. Once it reaches the bottom and the large gears 22 engage with the large ring gears 28, only one rotation of flywheel assembly 10 is required to return flywheel assembly 10 to the top.

Consider an example in which large gears 22 have a 10″ diameter, small gears 20 have a 1″ diameter. Flywheel 16 has a 100″ diameter. In the present example, consider flywheel assembly path 32 has a 20″ diameter. Considering the above, the path of travel for a complete circle is 3.14*20=62.8″ and path of travel for a half circle or hemisphere is 62.8″/2=31.4″. The circumference of large gears 22 are 3.14*10 i.e., 31.4″. Further, the circumference of small gears 20 are 3.14*1 i.e., 3.14″. For completion of the descent, small gears 20 have to complete 10 revolutions i.e., 31.4/3.14=10. Whereas, large gears 22 have to make 1 revolution to complete ascent i.e., 31.4/31.4=1. As specified above, the ratio between the small gears 20 and large gears 22 1:10. Here, the smaller the gear, the faster flywheel 16 spins on its downward path, as it takes more rotations and time to get there. Whereas, on the ascent, fewer rotations and time are needed to return the flywheel assembly 10 to the top of the flywheel assembly path 32. The above repeats leading to continuous rotation of flywheel assembly 10.

A person skilled in the art understands that the relationship of the gear ratio and the circumference of flywheel assembly path 32 and the diameter of flywheel 16 determine the energy required to return flywheel assembly 10 to the top of flywheel assembly path 32. Further, a person skilled in the art understands that flywheel 16 rotates due to accumulation of the gravitational force due to its construction and produces energy required to generate electricity.

Since the flywheel has the ability to rapidly deploy the stored kinetic energy within it, the rapid expression of the stored kinetic energy coupled with the shortened journey back to the top of the flywheel assembly path, due to the larger gears being employed, enable the flywheel assembly 10 to return to the top of the flywheel assembly path 32 with excess energy that can be used to generate electricity. For example, consider flywheel assembly 10 takes 10 rotations to go down (via small gears 20 rotating along small ring gears 26) and only takes one rotation to go up to the top (from bottom to the top of large ring gears 26 via large gears 22). Assuming that the circumference of small gears 20 are 3.14″ each, large gears are 31.4″ each and flywheel is 314″ with the hemisphere of flywheel assembly path 32 being 31.4″. Then, the distance travelled down by flywheel 16 is 314″*10 rotations (of small gear 20), i.e., 3140″ (i.e., 87.2 yards). Similarly, distance travelled up by flywheel 16 is 314″*1 rotation(s) (of large gear 22) is 314″ (i.e., 8.72 yards). The net resulting distance travelled is 87.2-8.72=78.48 yards of downhill energy with every complete rotation. The net energy generated by flywheel 16 is used to generate electricity.

FIGS. 4 and 6 show a schematic diagram, and a cross-sectional view, respectively of flywheel assembly 10 during the ascent. The flywheel assembly is supported, maintained, and stabilized within flywheel assembly path 32 by bearings 24, bearing races 30, flywheel assembly axle 23, flywheel assembly support arms 36 and one or more centreline axle(s) 38. On the ascent, the large gears 22 are driven by the accumulated kinetic energy in the flywheel 16. A person skilled in the art understands that the large ring gears 28 remain stationary and fixed at all times. During ascent, flywheel/rotor 16, small gears 20, large gears 22, flywheel assembly axle 23, bearings 24, stator 14, stator housing 12 and flywheel assembly support arms 36 move and remaining parts (small ring gears 26 and large ring gears 28, bearing races 30 and one or more fixed centreline axle(s) 38) remain stationary and fixed in the supporting structure. Further, small gears 20 do not come in contact with any other part (isolated) during the ascent and are not shown on FIG. 4 or 6.

FIG. 7 shows a side profile of flywheel assembly 10 connecting electric brushes or cable assembly 34 for transmission of energy generated by rotation of flywheel/rotor 16 within the stator 14 if the rotor 16 and stator 14 are positioned around the flywheel 16 itself. The stator 14 and the stator housing 12 which encompasses it, while traveling around the flywheel assembly path 32 with the flywheel assembly 10, do not rotate. Instead, the stator 14 and stator housing 12 are stabilized by the cable 34 or other stabilizing device to keep it from rotating with the rest of the assembly. As a result, electricity is generated, in accordance with one embodiment of the present invention. In order to use flywheel assembly 10 to generate electricity, the outside of flywheel 16 serves as a rotor, with stabilized stator 14 in stator housing 12 encircling it. (Alternatively, in a different depiction not shown here, the two ends of flywheel assembly axle 23 act as rotors with stabilized stators 14 and stator housings 12 surrounding the ends of the axle/rotors 23.) Here, the excess energy is used to generate electricity. The speed of rotation of flywheel assembly 10 is controlled by resistance caused by the load placed on the electrical generator/alternator. In one exemplary embodiment, the load is adjusted by a computer such as a PID controller.

The presently disclosed flywheel assembly utilizes the flywheel to act as an accumulator of gravitational forces, and the quadratic acceleration force of gravity to power electrical generators and/or alternators. Since gravity is the driving force of the flywheel, it is available 24 hours a day, 365 days a year, and is available geographically everywhere. In addition, it is not hazardous to the environment, and does not require the purchase of any fuel to run. Since it requires the purchase of no fuel, it is cheaper than fossil fuel and nuclear driven generators and available for use even in the most impoverished parts of the world.

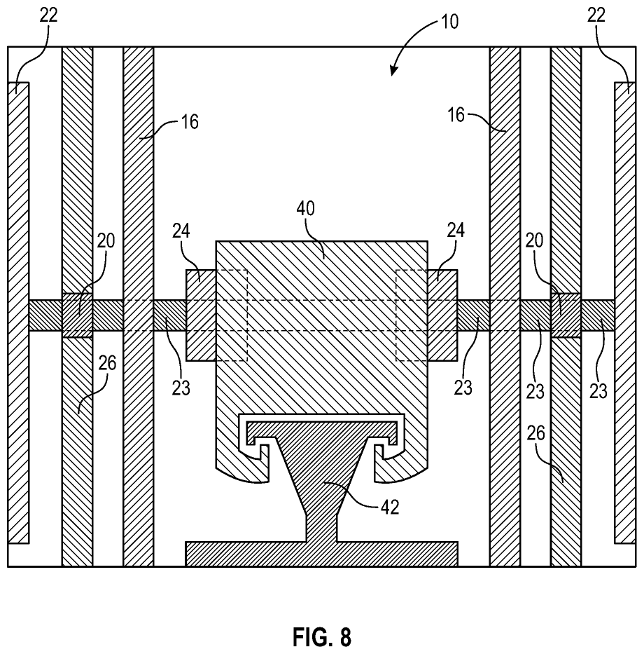

Now referring to FIG. 8, a cross-sectional view of a magnetic flywheel assembly 10 incorporating magnetic bearings 24 and gears is shown, in accordance with another embodiment of the present invention. In the present embodiment, magnetic flywheel assembly 10 includes magnetic small gears 20, magnetic large gears 22, magnetic bearings 24, small magnetic ring gears 26 and large magnetic ring gears 28 (not shown on FIG. 8) are provided in magnetic configuration instead of mechanical interfaced components, as explained above using FIGS. 1 to 7. Here, magnetic flywheel assembly axle 23 connects to electromagnetic carriage 40 via magnetic bearings 24. Further, electromagnetic carriage 40 encompasses a monorail 42. As can be seen from FIG. 8, monorail 42 suspends the electromagnetic carriage 40. The present embodiment allows it to operate magnetic flywheel assembly 10 without the need for support arms 36 and centreline axles 38. Such embodiment would include either semi-circular or fully circular ring gears, which by alternating magnetic currents permit interchangeable small and large gears.

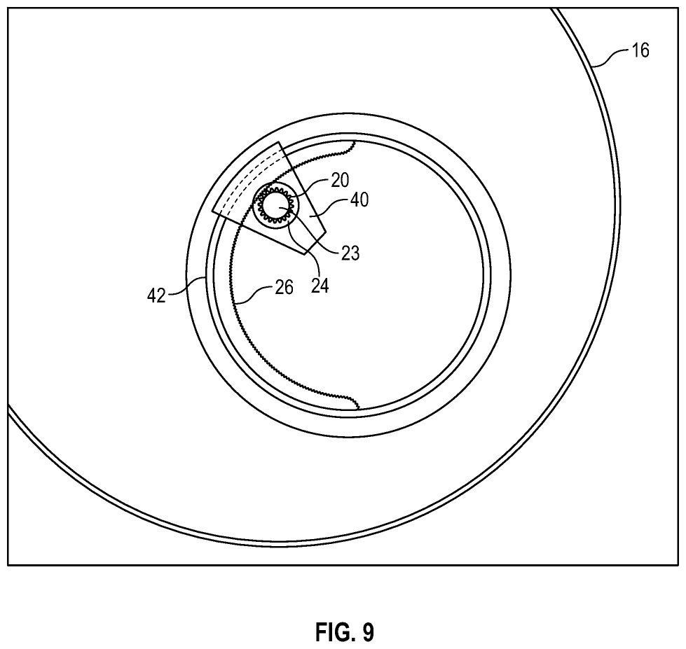

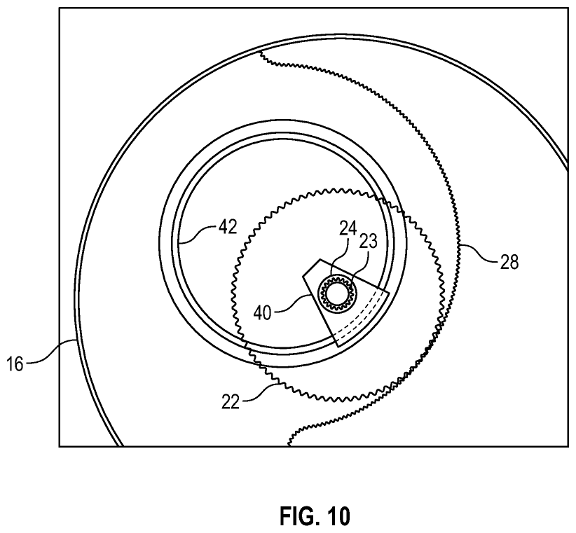

In the present embodiment, two flywheels 16 are provided to operate or power monorail 42, as monorail 42 is fixed in place and centered and made to suspend the electromagnetic carriage 40. Monorail 42 is provided to illustrate an exemplary embodiment incorporating magnetic components in place of mechanical bearings and rings, as explained above. However, any similar system can be used to transfer the kinetic energy produced by flywheels 16 to power the system. FIGS. 9 and 10 show schematic diagrams of magnetic flywheel assembly 10 incorporating magnetic suspension to center and hold flywheels 16 and monorail 42 via electromagnetic carriage 40 in descent and ascent modes, respectively. As presented above, during descent, small gears 20 engage with small ring gears 26 at the top of small ring gears 26. Small gears 20 rotate and comes down small ring gears 26 due to gravitational force. For each rotation of small gears 20, magnetic flywheel assembly 10 rotates once. In accordance with one present embodiment, small gears 20 complete ten rotations (due to its size, but may vary depending on the size of small gears) to reach from the top of small ring gears 26 to the bottom of small ring gears 26. Here, a person skilled in the art understands that flywheels 16 also completes ten rotations during the descent as flywheels 16 connect to magnetic flywheel assembly 10, by virtue of the magnetic flywheel assembly axel 23.

After small gears 20 roll down the small ring gears 26, the kinetic energy stored in flywheels 16 propels the magnetic flywheel assembly 10 such that large gears 22 come in contact with large ring gears 28. The kinetic energy accumulated in the flywheels 16 propels large gears 22 to travel along large ring gears 28 such that a single rotation of large gears 22 is sufficient to return the magnetic flywheel assembly 10 to the top of the flywheel assembly path. The above process repeats to generate or accumulate energy. As magnetic flywheel assembly axle 23 integrates electromagnetic carriage 40 instead of mechanical components, flywheels 16 operate smoothly and reduces wear and tear (operates without friction).

From the above, a person skilled in the art that the presently disclosed flywheel assembly relies on the gravitational forces stored kinetically in the flywheel(s). The flywheel assembly takes advantage of the relationship between time and gravity, and couples that with the mechanical advantage provided by differing gear ratios (of small gears and large gears), all within a defined flywheel assembly pathway.

The flywheel travels a defined circular pathway, a combination of semi-circular shapes of small and large ring gears. When the flywheel is traveling from the 12 o'clock position to the 6 o'clock position (with small gears along the small ring gears), gravity acts upon and drives the flywheel assembly. The longer (more time) gravity acts on a falling body, the more speed, and accordingly, the more kinetic energy is stored in the flywheel. On the trip down, a small gear is employed, requiring more time and more rotations to reach the bottom of the flywheel assembly pathway (until the 6 o'clock position, i.e., at the bottom of the small ring gear). All the while, the flywheel is storing kinetic energy in the flywheel.

The stored kinetic energy in the flywheel is then used to drive the larger gears. As a result, both the time and the distance required to return to the top of the flywheel assembly path (the 12 o'clock position, i.e., at the top of large ring gears) are reduced drastically.

In one example, the kinetic energy is calculated using

$${KE}_{ROT} = \frac{1}{2} I {ω}^{2} .$$

For the flywheel, the moment of Inertia (I) is defined as l=MR². For rotational velocity, ω, is measured in radians per second and is defined as

$$ω = \frac{v}{{R}^{2}} .$$

Where velocity (v) is measured in meters per second.

Combining the above equations results in

$${KE}_{ROT} = \frac{1}{2} {{MR}^{2} ( \frac{v}{R} )}^{2} .$$

Cancelling like terms in the above equation results in

$${KE}_{ROT} = \frac{1}{2} {Mv}^{2} .$$

Here, linear velocity (V) is dependent on the radius of the rolling object. In the present invention, the rolling object is the small gear that is going down and the large gear that is going up. Thus, as the radius increases, the velocity also increases. Therefore, the linear velocity is calculated as

$$v = f ( R ) , {KE}_{{ROT}_{Down}} = \frac{1}{2} {M}_{Down} {f ( {R}_{Down} )}^{2} and {KE}_{{ROT}_{Up}} = \frac{1}{2} {M}_{Up} {f ( {R}_{Up} )}^{2} .$$

Since the mass does not change in the system, the mass is calculated as:

M_{Down}=M_{Up}.

In the present invention, the small gear and the large gear position on the same axle. As such, the kinetic energy is directly proportional to the radius of the gear, which results in:

KE_{ROT}_{_{Up}}>KE_{ROT}_{_{Down}}.

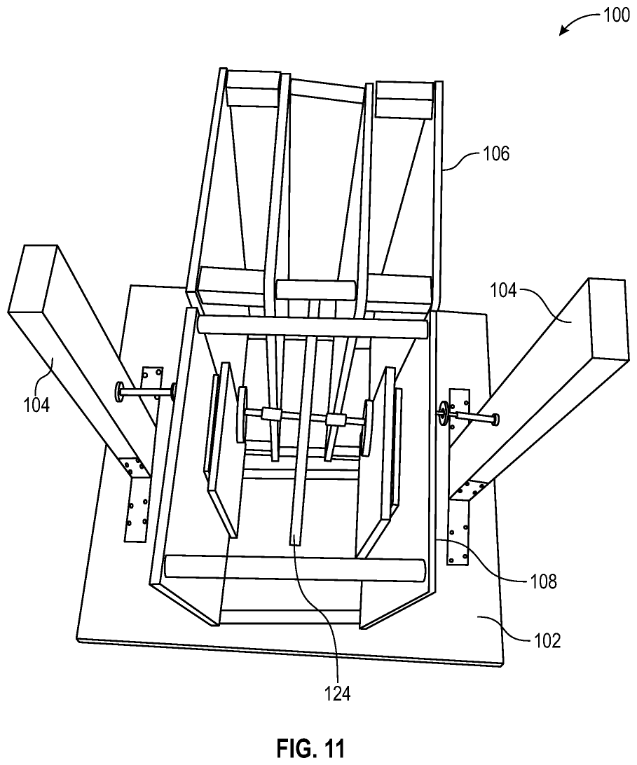

Now referring to FIGS. 11 through 15, a prototype of a flywheel assembly and supporting structure 100 is shown, in accordance with one exemplary embodiment of the present invention. FIG. 11 shows a perspective view of exemplary flywheel assembly and supporting structure 100. Flywheel assembly and supporting structure 100 includes a base 102. Base 102 comes in a flat configuration. Base 102 is made of cement, metal, plastic, wood or any suitable material. Base 102 encompasses end plates 104 made up of suitable material. End plates 104 extend from base 102 at its distal ends, for example.

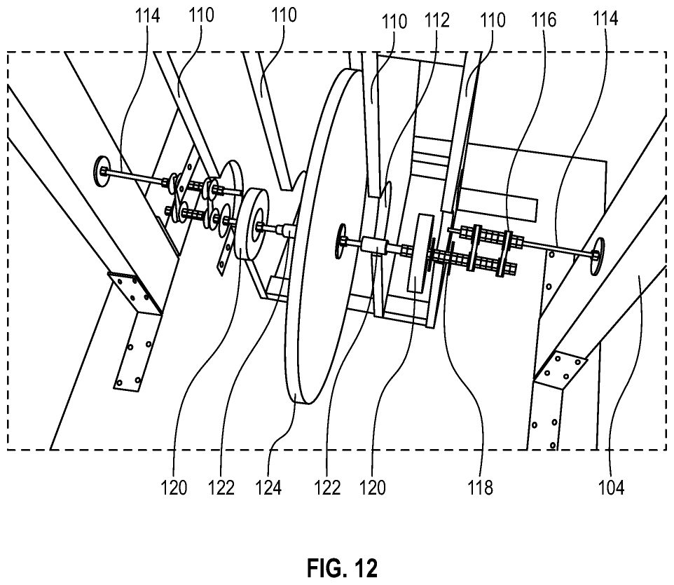

Flywheel assembly and supporting structure 100 includes first housing 106 and second housing 108, made of suitable material. FIG. 12 shows a perspective view of first housing 106, in accordance with one exemplary embodiment of the present invention. First housing 106 includes first walls 110. First walls 110 extend from base 102. In one implementation, first walls 110 encompasses semi-circular first ring gears or small ring gears 112. Further, end plates 104 provide one or more centreline axle(s) 114. Centreline axles 114 extend from end plates 104. Further, centreline axles 114 connect to support arms 116. Support arms 116 connect to axle 118 (or flywheel assembly axle 118). Here, support arms 116 extend from and connect centreline axles 114 and support arms 116.

Axle 118 presents large gears 120, small gears 122, and flywheel 124. As can be seen, large gears 120 and small gears 122 position adjacent to each other. Each of large gears 120 and small gears 122 encompasses gear teeth for driving flywheel 124.

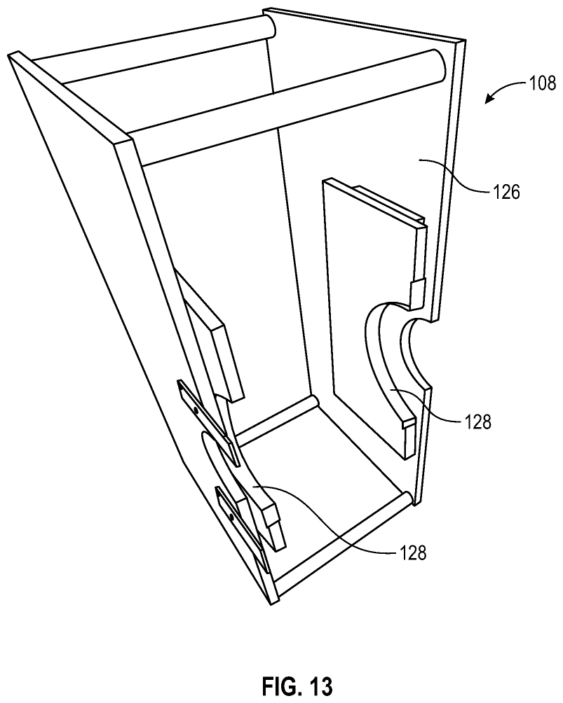

Now referring to FIG. 13, a perspective view of second housing 108 is shown, in accordance with one exemplary embodiment of the present invention. Second housing 108 presents second walls 126 extending from base 102. Second walls 126 include large semi-circular ring gears 128.

When first housing 106 and second housing 108 are connected (FIG. 11), large gear 120 aligns with large semi-circular ring gear 128, and small gear 122 aligns with small semi-circular ring gear 112. Further, the bottom of small semi-circular ring gears 112 align substantially with the bottom of the large semi-circular ring gears 128, except within a different plane so as to align the semi-circular ring gears with their respective matching small gears 122 and large gears 120. Similarly, the top of small semi-circular ring gears 112 align substantially with the top of the large ring gears 128, except within a different plane so as to align the semi-circular ring gears with their respective matching small gears 122 and large gears 120. Small ring gears 112 and large ring gears 128 form a substantial circular configuration.

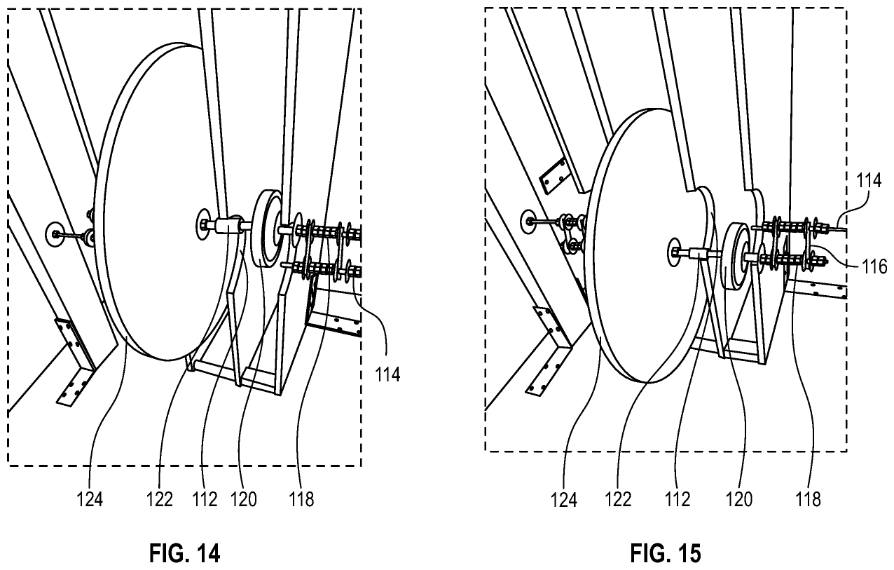

Now referring to FIGS. 13, 14, and 15, operational features of flywheel assembly and supporting structure 100 are explained. At first, small gears 122 position at the top of small ring gears 112, as shown in FIG. 14. Here, small gears 122 rotate as the flywheel assembly descends, causing flywheel 124 to rotate. Small gears 122 rotate and come down small ring gears 112 and reach the bottom of small ring gears 112, as shown in FIG. 15. Concurrently, flywheel 124 travels down and picks up speed with each rotation, storing the energy as it goes down. Once small gears 122 reach the bottom or end of small semi-circular ring gears 112, the energy stored in flywheel 124 causes large gears 120 to come in contact with large semi-circular ring gears 128 in second housing 108 (large ring gears 128 shown in FIG. 13). Specifically, large gears 120 come in contact with large semi-circular ring gears 128 at the bottom. Here, the accumulated energy in flywheel 124 generated during the multiple rotations on the path down at small ring gears 112 is more than sufficient to complete the rotation of large gears 120 along large semi-circular ring gears 128. Flywheel 124 completes one rotation for one rotation of large gears 120. As such, when large gears 120 travel from the bottom of large semi-circular ring gears 128 to the top of large semi-circular ring gears 128, both large gears 120 and flywheel 124 complete one rotation each. Once large gears 120 reach the top of large semi-circular ring gears 128, small gears 122 take over and engage with small semi-circular ring gears 112 to repeat/start the downward path, as explained above. This results in continuous rotation of flywheel 124.

From the above, a person skilled in the art knows that the presently disclosed flywheel assembly relies on the gravitational forces stored kinetically in the flywheel. The flywheel assembly takes advantage of the relationship between time and gravity, and couples that with the mechanical advantage provided by differing gear ratios (of small gear and large gear), all within a defined flywheel pathway.

The flywheel travels a defined circular pathway, a combination of semi-circular shapes of small and large ring gears. When the flywheel is traveling from the 12 o'clock position to the 6 o'clock position (with small gear along the small ring gear), gravity acts upon and drives the flywheel. The longer (more time) gravity acts on a falling body, the more speed and rotations, and accordingly, the more energy is stored in the flywheel. Because Gravity is quadratic and nonlinear, the storage of the kinetic energy is to the second degree. On the trip down, small gears are employed, requiring more time and more rotations to reach the bottom of the flywheel pathway (until the 6 o'clock position, i.e., at the bottom of the small ring gears). All the while, the flywheel is storing gravitational kinetic energy in the flywheel, quadratically.

On the trip back up (upward path), different, much larger gears are employed which has the effect of shortening the path back up, and greatly increasing the speed of travel of the flywheel. The stored energy in the flywheel is then used to drive the larger gears. As a result, both the time and the distance required to return to the top of the flywheel path (the 12 o'clock position, i.e., at the top of large semi-circular ring gears) are reduced drastically. Energy, in the form of gravitational Units of force per Second (Newtons) is stored in the flywheel and not fully expended in returning the flywheel to its point of origin.

The flywheel assembly ensures that gravitational forces continue to put energy into the system/flywheel as it operates, and no laws of physics are violated. In other words, no energy is created, it is only transformed from dynamic gravitational force to kinetic force. As the Kinetic Energy up is greater than the Kinetic Energy down (because it has accumulated kinetic energy in the flywheel on the long way down), it allows the system to complete a full revolution to start again at the top. Thus, the system harvests gravitational energy kinetically. The amount of energy harvested is dependent on the differing dimensions of the two gears, the size and makeup of the flywheel, the size of the flywheel assembly path, and the type of bearings used. All of these factors can be manipulated so as to maximize the energy output and could easily allow a load to be placed on the shaft to generate electricity.

In another embodiment (not shown) the ring gears are not semi-circular but are completely circular. The circular ring gears are mounted permanently in the structure housing parallel to each other but in different planes so as to coincide with the respective small and large gears on the flywheel assembly. However, in this embodiment, the small and large gears are not permanently affixed to the flywheel assembly axle but are permitted to spin freely on the flywheel assembly axle. Also in this embodiment, the small and large gears are each equipped with electromagnetic shaft brakes which permit the small and large gears to alternate locking onto the flywheel assembly axle. On the trip down, the electromagnetic shaft brakes on the small gear are engaged locking them firmly to the flywheel assembly axle causing the flywheel to spin multiple times on the trip down the flywheel path until the flywheel assembly reaches the bottom. At the bottom, the electromagnetic shaft brakes on the small gears disengage and the electromagnetic shaft brakes on the large gears engage locking them firmly to the flywheel assembly axle. This causes the flywheel assembly, powered by the kinetic energy stored in the flywheel, to climb the large circular ring gear back up to the top of the flywheel assembly path, at which point the electromagnetic shaft brakes on the large gears disengage and the electromagnetic shaft brakes on the small gears reengages starting the process all over again. The advantage of this embodiment is that it permits the teeth on both the small and large gears to constantly be engaged with the respective teeth on the small and large ring gears.

In the above description, numerous specific details are set forth such as examples of some embodiments, specific components, devices, methods, in order to provide a thorough understanding of embodiments of the present disclosure. It will be apparent to a person of ordinary skill in the art that these specific details need not be employed, and should not be construed to limit the scope of the disclosure.

In the development of any actual implementation, numerous implementation-specific decisions must be made to achieve the developer's specific goals, such as compliance with system-related and business-related constraints. Such a development effort might be complex and time consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. The claimed invention set forth in the claims may not intended to be limited to the embodiments shown herein, but is to be accorded the widest scope consistent with the principles and novel features disclosed herein. It is contemplated that additional embodiments are within the spirit and true scope of the disclosed invention.

What is claimed is:

1. A flywheel assembly, comprising:
an axle;
a first gear connecting said axle;
a first ring gear configured to allow said first gear to travel along its path;
a second gear connecting said axle, wherein said second gear positions adjacent to said first gear, and wherein said second gear is larger than said first gear;
a second ring gear configured to allow said second gear to travel along its path, wherein said second ring gear aligns with said first ring gear but in a different plane and forms a substantial circular configuration with said first ring gear; and
a flywheel connecting said axle,
wherein said first gear travels down said first ring gear powered by gravitational force, bringing down said flywheel and causing said flywheel and said second gear to rotate, wherein said flywheel picks up speed and stores kinetic energy as said flywheel travels down, and upon reaching the end of said first ring gear at the bottom, said flywheel causes said second gear to engage with said second ring gear, wherein upon engagement with said second ring gear, the kinetic energy stored within said flywheel causes said second gear to travel up said second ring gear, wherein said flywheel travels up along said second ring gear to the top end of said second ring gear in fewer rotations and in shorter time period than said flywheel travelling down said first ring gear, and wherein said flywheel reaches the top of said second ring gear and connects said first gear to said first ring gear to continue rotation of the flywheel.

2. The flywheel assembly of claim 1, wherein said first ring gear comprises a first semi-circular ring gear and said second ring gear comprises a second semi-circular ring gear.

3. The flywheel assembly of claim 2, wherein the bottom of second semi-circular ring gear aligns with the bottom of said first semi-circular ring gear, but in a different plane and wherein the top of second semi-circular ring gear aligns with the top of said first semi-circular ring gear, but in a different plane.

4. The flywheel assembly of claim 2, wherein said axle comprises bearings, and wherein said bearings connect said first gear, said second gear and said flywheel to said axle.

5. The flywheel assembly of claim 2, wherein said axle comprises support arms.

6. The flywheel assembly of claim 5, wherein said support arms connect said axle to one or more centreline axles, and wherein said one or more centreline axles help to connect and stabilize said flywheel, said axle, said first gear and said second gear.

7. The flywheel assembly of claim 2, wherein said second gear does not come in contact with said second semi-circular ring gear when said first gear travels down said first semi-circular ring gear bringing down said flywheel.

8. The flywheel assembly of claim 2, wherein said first gear does not come in contact with said first semi-circular ring gear when said second gear travels up said second semi-circular ring gear bringing up said flywheel.

9. The flywheel assembly of claim 2, further comprises a rotor and a stator for the generation of electricity, wherein said flywheel assembly further comprises a cable, and wherein said cable transmits the electricity generated by the rotation of the rotor within the stator caused by rotation of said flywheel.

10. The flywheel assembly of claim 2, wherein each of said first gear, said first ring gear, said second gear and said second ring gear comprises magnetic configuration.

11. The flywheel assembly of claim 10, wherein said axle connects to an electromagnetic carriage, and wherein said electromagnetic carriage connects to a monorail to connect and stabilize said flywheel, said axle, said first gear and said second gear.

12. The flywheel assembly of claim 2, wherein the size of said first gear and said second gear is in the ratio greater than that of 1:1.

13. The flywheel assembly of claim 2, wherein the speed of rotation of said flywheel is controlled by resistance caused by placing a load or using a computer.

14. The flywheel assembly of claim 1, wherein said first ring gear comprises a first fully circular ring gear and said second ring gear comprises a second fully circular ring gear, said first fully circular ring gear and said second fully circular ring configured for interchangeable operation of said first gear and said second gear.

15. A flywheel assembly, comprising:
an axle;
a first gear connecting said axle;
a first semi-circular ring gear configured to allow said first gear to travel along its path;
a second gear connecting said axle, wherein said second gear positions adjacent to said first gear, and wherein said second gear is larger than said first gear;
a second semi-circular ring gear configured to allow said second gear to travel along its path, wherein said second semi-circular ring gear aligns with said first semi-circular ring gear except in a different plane, and forms a substantial circular configuration with said first semi-circular ring gear; and
a flywheel connecting said axle,
wherein each of said first gear, said first ring gear, said second gear and said second ring gear comprises magnetic configuration,
wherein said first gear travels down said first ring gear, powered by gravitational force, bringing down said flywheel and causing said flywheel and said second gear to rotate, wherein said flywheel picks up speed and stores kinetic energy as said flywheel travels down, and upon reaching the end of said first ring gear at the bottom, said flywheel causes said second gear to engage with said second ring gear, wherein upon engagement with said second ring gear, the kinetic energy stored within said flywheel causes said second gear to travel up said second ring gear, wherein said flywheel travels up along said second ring gear to the top end of said second ring gear in fewer rotations in shorter time period than said flywheel travelling down said first ring gear, and wherein said flywheel reaches the top of said second ring gear and connects said first gear to said first ring gear to continue rotation of the flywheel.

16. The flywheel assembly of claim 15, wherein said first ring gear comprises a first semi-circular ring gear and said second ring gear comprises a second semi-circular ring gear.

17. The flywheel assembly of claim 15, wherein said axle connects to an electromagnetic carriage, and wherein said electromagnetic carriage connects to a monorail to connect and stabilize said flywheel, said axle, said first gear and said second gear.

18. The flywheel assembly of claim 15, wherein the size of said first gear and said second gear is in the ratio greater than that of 1:1.

19. The flywheel assembly of claim 15, further comprises a rotor and a stator for the generation of electricity, wherein said flywheel assembly further comprises a cable, and wherein said cable transmits the electricity generated by the rotation of the rotor within the stator caused by rotation of said flywheel.

20. The flywheel assembly of claim 15, wherein said first ring gear comprises a first fully circular ring gear and said second ring gear comprises a second fully circular ring gear, said first fully circular ring gear and said second fully circular ring configured for interchangeable operation of said first gear and said second gear.

21. A method of providing a flywheel assembly, the method comprising the steps of:
providing an axle;
providing a first gear connecting said axle;
providing a first ring gear for allowing said first gear to travel along its path;
providing a second gear having larger size than said first gear;
connecting said second gear to said axle, said second gear positioning adjacent to said first gear;
providing a second ring gear configured for allowing said second gear to travel along its path;
aligning said second ring gear with said first ring gear but in separate planes forming a substantial circular configuration with said second ring gear and said first ring gear;
providing a flywheel connecting said axle;
rotating said first gear and causing said flywheel to rotate;
causing said first gear to travel down said first ring gear, powered by gravitational force, bringing down said flywheel;
generating and storing kinetic energy as said flywheel travels down;
causing said second gear to connect second ring gear using the kinetic energy stored therein;
causing said second gear to travel up along said second ring gear in fewer rotations and in shorter time than said flywheel travelling down said first ring gear;
causing said flywheel to reach the top of said second ring gear; and
connecting said first gear to said first ring gear for continuing rotation of the flywheel.

22. The method of claim 21, further providing said first ring gear to comprise a first semi-circular ring gear and said second ring gear to comprise a second semi-circular ring gear.

23. The method of claim 22, further comprising:
providing a rotor and a stator for the generation of electricity;
providing a cable; and
connecting said cable to said flywheel assembly for transmitting the electricity generated by the rotation of said rotor within the stator caused by rotation of said flywheel.

24. The method of claim 22, further comprising providing support arms connecting said axle with one or more centreline axles for stabilizing said flywheel, said axle, said first gear and said second gear.

25. The method of claim 22, further comprising providing said flywheel having a diameter or circumference greater than the diameter or circumference of a path said flywheel takes.
